(19) United States
(12) Patent Application Publication
(10) Pub. No.: US 2026/0368767 A1
(43) Pub. Date: Nov. 19, 2026

(54) QUANTITATIVE RESEARCH SYSTEM AND METHOD OF USING THE SAME

(71) Applicant: Converge, LLC, Scottsdale, AZ (US)

(72) Inventors: Douglas Stauffer GRIFFEN, Scottsdale, AZ (US); Sam Sheppard Griffen, Scottsdale, AZ (US)

(21) Appl. No.: 19/206,342

(22) Filed: May 13, 2025

(51) Int. Cl. G06Q 30/0203; G06Q 10/0637

(52) U.S. Cl. CPC G06Q 30/0203; G06Q 10/0637

(57) ABSTRACT

The present disclosure is directed to quantitative research systems and methods of using the same. In some embodiments, the quantitative research system may be used to solicit feedback. In this environment, the quantitative research system may be configured to receive a feedback solicitation from a facilitator device, send participants feedback solicitations, and analyzed the received feedback in real-time to facilitate generating actionable tasks.

### TECHNICAL FIELD

This document relates to quantitative research systems and methods of using the same. More specifically, this document relates to systems and methods for facilitating participant feedback in real-time.

### BACKGROUND

Honest feedback is difficult to gather. Traditionally, a series of participants would be brought together in a room by a facilitator. The facilitator will have brought with him or her questions to ask the series of participants. For example, 5 residents of a community may meet in a conference room with a community representative who is acting as the facilitator. The community representative would then solicit feedback from the participants, or community residents, about their views on the community or their suggestions for improvements. This traditional way of gathering and assessing feedback has several flaws. First, it fails to account for the fact that when humans are in groups and have to share opinions in front of each other, those opinions may be muted by people's unwillingness to share opinions in front of others. This results in feedback that is either incomplete or inaccurate. Thus, the lack of participant anonymization is a problem with the traditional feedback method. Second, the traditional feedback method relies on the facilitator's subjective identification of issues raised by each individual. Third, the facilitator may be overwhelmed with the tasks required of them during the feedback session. The facilitator may be tasked with managing the discussion, analyzing as much feedback as they can in real-time, and trying to develop further questions to elucidate issues of importance to the stakeholders at the same time.

Additionally, once the facilitator has the data gathered, they may realize during their later analysis that follow-up questions on some topics would have been helpful, but the facilitator did not think of them at the moment. At this point, the facilitator may have limited means to follow up with the participant or the participants who provided the data. These inefficiencies reduce the effectiveness and increase the cost of feedback solicitations.

Traditional feedback systems also fail to provide either the facilitator or other stakeholders with actionable items. Traditional feedback systems rely on either the facilitator or the stakeholder to review large volumes of data, attempt to parse the data in a meaningful way, correctly interpret the data, and generate actionable items from the interpreted data. This slows feedback, slows the implementation of the feedback, and can reduce the effectiveness of the feedback session entirely.

### SUMMARY

In some embodiments, a system for prescribing actionable tasks from iterative, real-time quantitative participant input to advance a strategic plan includes a server. The server may be communicatively coupled to a plurality of participant devices and at least one facilitator device. A processor may be communicatively coupled to the server and configured to receive, from each participant device, a participant identifier. In some embodiments, the processor may be configured to receive, from the at least one facilitator device, a feedback solicitation. The processor may group, using a grouping module, the plurality of participant devices into subgroups. The grouping module may be configured to group the plurality of participant devices based on the participant identifier and the feedback solicitation. The processor may be configured to generate, using a participant feedback solicitation module, a participant feedback solicitation for each participant device in each subgroup. The processor may send, using the participant feedback solicitation module, the participant feedback solicitation to each participant device in each subgroup. The processor may receive in real-time, a plurality of participant feedbacks from the plurality of participant devices, the plurality of participant feedbacks comprising quantitative inputs from each of the participant devices. The processor may generate, from the plurality of participant feedbacks, a subgroup feedback and a consolidated feedback, the subgroup feedback and the consolidated feedback generated automatically by an analysis module configured to identify at least one category of the plurality of participant feedbacks and identify at least one theme of the plurality of participant feedbacks. In some embodiments, the analysis module may also evaluate the tone of the participant feedbacks.

In some embodiments, the processor is configured to present, using a graphical user interface module, the consolidated feedback to the facilitator device using a graphical user interface that includes at least one identified category of the plurality of participant feedbacks and at least one identified theme of the plurality of participant feedbacks. The processor may be configured to generate, with references to a stakeholder input module, a second participant feedback solicitation, the second participant feedback solicitation generated by the analysis module with reference to the category, theme, and a stakeholder input identified in the stakeholder input module. The processor may generate in real-time and display at the graphical user interface actionable tasks to advance the strategic plan based on responses to the second participant feedback solicitation.

In some embodiments, the server is communicatively coupled to an observer device, and the processor is configured to receive an observer prompt from the observer device. In some embodiments, the second participant feedback solicitation is generated by the analysis module with reference to the observer prompt. The participant solicitation feedback module may include a translation module, the translation module configured to translate the participant feedback solicitation into a language of the participant device.

In some embodiments, the processor may be configured to generate, using an action item module, a plurality of action items. The plurality of action items may be generated automatically by the action item module by comparing at least one stakeholder input to the at least one category of the plurality of participant feedbacks.

In some embodiments, the analysis module includes a filtering module configured to automatically filter the plurality of participant feedbacks. The filtering module may be configured to filter the plurality of participant feedbacks by an attribute of each participant device. The attribute of each participant may include a participant age and a participant gender. In some embodiments, the graphical user interface generated for the facilitator device includes a first section displaying the category of the plurality of participant feedbacks and a second section displaying at least one of the plurality of participant feedbacks from one of the plurality of participant devices.

In some embodiments, the analysis module is configured to identify a second category of the feedback. The first section of the graphical user interface generated for the facilitator displays the second category of the plurality of participant feedbacks. In some embodiments, the grouping module is configured to group the plurality of participant devices based on a facilitation metric. In some embodiments, the receipt of the plurality of participant feedbacks from the participant devices further includes, automatically translating, using a translation module, the audio inputs from each participant device into a selected language. In some embodiments, the server includes a trend identification module configured to identify trends in the plurality of participant feedbacks.

A system for prescribing actionable tasks from iterative real-time quantitative participant input to advance a strategic plan may include a server having a processor. The processor may be configured to receive, from a facilitator device communicatively coupled to the server, a facilitator feedback solicitation. The processor may generate, from the facilitator feedback solicitation, a plurality of feedback solicitations. In some embodiments, the processor may send, to a plurality of participant devices communicatively coupled to the server, one of the plurality of feedback solicitations. The processor may receive in real-time, from each participant, a participant feedback, wherein each participant's feedback comprises a quantitative input. In some embodiments, the processor may summarize, using a summary module, the participant feedbacks into a summarized feedback. The processor may be configured to identify in real-time a category of the summarized feedback.

In some embodiments, the processor may be configured to generate a graphical user interface displaying a facilitator view. The facilitator view may include a first section displaying the summarized feedback, a second section displaying the category of the summarized feedback, and a third section displaying at least one participant feedback from one of the plurality of participants in support of the category of the summarized feedback. In some embodiments, the processor is configured to generate a subsequent feedback solicitation as a rate function based on feedback received from each participant and a strategic stakeholder interest. The processor may generate in real-time and display at the facilitator device actionable tasks to advance the strategic plan based on responses to the rate function.

In some embodiments,, wherein the subsequent feedback solicitation comprises a plurality of subsequent feedback solicitations, each of the plurality of subsequent feedback solicitations generated for a specific participant device.

In some embodiments, wherein the processor is further configured to group, using a grouping module, the plurality of participant devices into subgroups, each participant device being assigned to the subgroup based on a common facilitation metric.

In some embodiments, a system for prescribing actionable tasks from iterative real-time quantitative participant input to advance a strategic plan. The system may include a server communicatively coupled to a plurality of participant devices and at least one facilitator device. The system may also include a processor communicatively coupled to the server and configured to receive, from the at least one facilitator device, a feedback solicitation. The processor may also be configured to generate, using a participant feedback solicitation module, a participant feedback solicitation. The processor may send, using the participant feedback solicitation module, the participant feedback solicitation to each participant device. The processor may be configured to receive, from each participant device, a plurality of participant feedbacks, the plurality of participant feedbacks comprising a quantitative input from each of the participant devices.

In some embodiments, the processor may be configured to generate, from the plurality of participant feedbacks, a consolidated feedback, the consolidated feedback generated automatically by an analysis unit configured to identify at least one category of the plurality of participant feedbacks. The processor may be configured to present, using a graphical user interface module, the consolidated feedback to the facilitator device using a graphical user interface that includes at least one identified category of the plurality of participant feedbacks.

In some embodiments, the processor may generate, with references to a stakeholder input module, a second participant feedback solicitation, the second participant feedback solicitation generated by the analysis module with reference to the category of the plurality of participant feedbacks and a stakeholder input identified in the stakeholder input module.

In some embodiments, the analysis module is further configured to identify a theme of the plurality of participant feedbacks.

In some embodiments, the analysis module is configured to generate the consolidated feedback based on at least one theme of the plurality of participant feedback.

In some embodiments, the second participant feedback solicitation is generated based on the theme of the plurality of participant feedbacks. In some embodiments, generating the participant feedback solicitation for each participant device comprises a determination of a language of the participant device.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS.

FIG. 1 shows a schematic view of a quantitative feedback system according to some embodiments.

FIG. 2 shows a flow diagram showing an example of the quantitative feedback system's processor generating a second feedback solicitation according to some embodiments.

FIG. 3 shows a flow diagram showing an example of the quantitative feedback system's processor generating a second feedback solicitation according to some embodiments.

FIG. 4 shows a graphical user interface generated for a facilitator, according to some embodiments.

FIG. 5 shows a graphical user interface generated for a facilitator, according to some embodiments.

FIG. 6 shows a graphical user interface generated for a facilitator, according to some embodiments.

FIG. 7 shows a graphical user interface generated for a facilitator, according to some embodiments.

FIG. 8 shows a graphical user interface generated for a facilitator, according to some embodiments.

FIG. 9 shows a graphical user interface generated for a facilitator, according to some embodiments.

### DETAILED DESCRIPTION

The following detailed description provides numerous specific details. Those skilled in the relevant arts understand that embodiments of the disclosure may be practiced without these specific details. The disclosure may also be practiced in different and alternative configurations.

Unless specifically noted, it is intended that the words and phrases in the specification and the claims be given their plain, ordinary, and accustomed meaning to those of ordinary skill in the applicable arts. The singular forms “a,” “an,” and “the” include plural referents unless the context clearly dictates otherwise. Thus, for example, a reference to “a step” includes a reference to one or more of such steps. The words “exemplary,” “example,” “embodiment,” or various forms thereof are used herein to mean serving as an example, instance, or illustration. Any aspect or feature described herein as “exemplary” or as an “example” is not necessarily to be construed as preferred or advantageous over other aspects or designs. The examples are provided solely for purposes of clarity and understanding and do not limit or restrict the disclosure. It is to be appreciated that a myriad of additional or alternate examples of varying scope could have been presented, but have been omitted for purposes of brevity.

Throughout the description and claims of this specification, the words “comprise” and “contain” and variations of the words, for example, “comprising” and “comprises,” mean “including but not limited to,” and are not intended to (and do not) exclude other components.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain, and ordinary meaning of the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means,” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

The present disclosure is directed to quantitative research systems and methods of using the same. In some embodiments, the quantitative research system may be used to solicit feedback. In this environment, the quantitative research system may be configured to receive a feedback solicitation from a facilitator device. The facilitator device may be associated with a facilitator. In common parlance, the facilitator may be the host who is running the meeting, or the moderator of the discussion. In some embodiments, the feedback solicitation is received by a communication module of the quantitative research system. The communication module may be configured to receive the solicitation feedback from the facilitator device and also be configured to send participant feedback solicitations to the participant devices. Each participant device may be associated with a participant. In common parlance, the participant may be a member of the group whose feedback is solicited. The participant device allows a participant to provide an input. In some embodiments, the input may be text typed by the participant or generated using a voice-to-text feature, an audio input, a video input, or any other kind of input. As used herein, an “audio input,” “video input,” or any other input does not lose its specifier (i.e. “audio”) even if it is converted to a different format, such as, for example, a text file with a transcript of the audio of the audio file. In another example, an “audio input” is still an “audio input” even if the file received by a server, processor, or other electronic device is no longer a sound file (for example). The audio input component, for example, allows the participant to speak responses to the participant device, have the participant's responses recorded by the participant device's audio input, and allows for the participant device to create an audio file with each participant's audio input. Each participant's feedback, which in some embodiments may include an audio input, is then transmitted from each participant's device to the communication module. The communication module is configured to receive the participant feedback from the participant feedback devices. In some embodiments, the quantitative system also includes an observer device associated with an observer. The observer device may also be in communication with the communication module. The observer device may receive an observer prompt from the observer and transmit the observer prompt to the communication module. In some embodiments, the communication module then analyzes the observer prompt by sending it to the processor for further analysis. In some embodiments, the observer prompt is passed by the communication module to the facilitator device so that the facilitator may view the observer's prompt. In popular parlance, the observer may be a stakeholder wanting solicited feedback. For example, the observer device may be associated with a manager of a housing complex and the participants may be associated with residents of the housing complex.

In some embodiments, the feedback session may operate with groups of about 30 to 40 participants. The facilitator may be able to generate prompts for each participant, either by giving live instructions over an audio connection with each participant or by sending text-based messages to each participant. Each participant's responses are anonymous. Each participant may speak their response to the prompts to an audio input associated with each participant's device. Anonymizing participant feedback improves the quality of the feedback especially if more sensitive topics, such as discussions about satisfaction with leadership or politics, are part of the feedback session. In some embodiments, the facilitator receives real-time results with filters, graphs, and analytics happening in real-time. Participants or observers may see graphs or other data as permitted by the facilitator. In some embodiments, “real-time” means less than 1 second between the actions. In some embodiments, real-time may be between 1 and 3 seconds. In some embodiments, real-time may mean 10 milliseconds, 1 millisecond, or less.

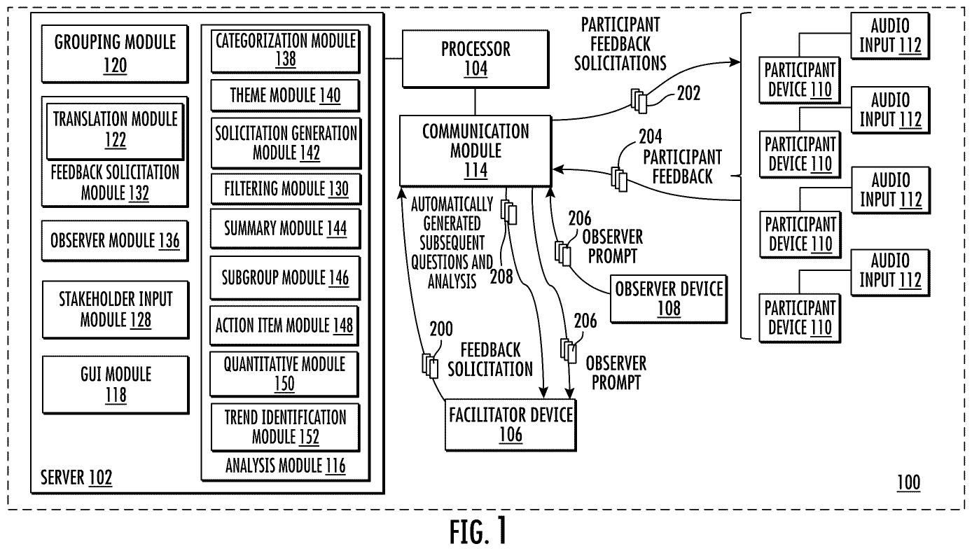

FIG. 1 shows quantitative research system 100, according to some embodiments. Quantitative research system 100 has server 102 communicatively coupled to processor 104. Processor 104 is operatively coupled to communication module 114. Communication module 114 is configured to receive communication from devices, send communications to devices, and act as a conduit through which information flows to and from processor 104. Processor 104 is configured to perform operations. The operations may be stored on server 102 in modules. When processor 104 needs to perform a set of operations, processor 104 may use a module. The module is a set of instructions for processor 104 to follow.

Communication module 114 is operatively coupled with many devices. For example, communication module 114 may be communicatively coupled to facilitator device 106, participant devices 110, observer device 108. Facilitator device 106 may be associated with a facilitator who is leading or managing the discussion. Participant devices 110 may be associated with participants who are asked to give feedback. Each participant device is associated with an audio input 112. Audio input 112 may be a microphone associated with a participant device 110. For example, audio input 112 may be a microphone integrated into a phone, laptop, or other network-capable device. Observer device 108 may be associated with an observer. The observer may be a stakeholder who wants to view the feedback. Observer device 108 may be configured to send an observer prompt to 206 to communication module 114. In some embodiments, observer prompt 206 may be passed by the communication module 114 to processor 104 for further analysis, or observer prompt 206 may be passed to facilitator device 106 so the facilitator may see the content of observer prompt 206.

In some embodiments, communication module 114 is configured to receive feedback solicitation 200 from facilitator device 106. Feedback solicitation 200 may be passed by communication module 114 to processor 104. Processor 104 is configured to employ feedback solicitation module 132 to generate a plurality of participant feedback solicitations 202. Feedback solicitation module 132 may be configured to transform feedback solicitation 200. For example, feedback solicitation module 132 may be configured to rewrite feedback solicitation 200 in a way that is clearer to a participant, or feedback solicitation module 132 may use translation module 122 to translate feedback solicitation 200 into the language of the participant. In some embodiments, translation module 122 uses the commercially available translation program Deep L. In some embodiments, all translations are done in real-time. Each participant device 110 may have a participant identifier associated with it. The participant identifier may be used to associate anonymous responses with a participant device. While the facilitator will still see anonymize data, the participant identifier may permit deeper analysis of the data. In some embodiments, the participant identifier may have additional information associated with the participant, such as a participant attribute. The participant attribute may be, for example, the language the participant communicates in, the participant's age, gender, marital status, or others.

In some embodiments, feedback solicitation module 132 may generate a plurality of participant feedback solicitations 202. In some embodiments, each participant device receives the same plurality of participant feedback solicitations 202. In some embodiments, feedback solicitation module 132 generates a custom participant feedback solicitation 202 for one or more participant devices 110 based on the participant attribute of the participant.

In some embodiments, communication module 114 sends a plurality of participant feedback solicitations 202 to a plurality of participant devices 110. Each participant, using their participant devices 110 and, in some embodiments, audio inputs 112, generates participant feedback 204 in response to participant feedback solicitation 202. In some embodiments, communication module 114 receives participant feedback 204. Communication module 114 may receive participant feedback 204 in real-time. Communication module 114 may also receive participant feedback 204 in real-time as an audio input from participant devices 110.

As communication module 114 receives participant feedback 204, it is analyzed by analysis module 116. Analysis module 116 is configured to analyze feedback solicitation 200, a plurality of participant feedback solicitations 202, participant feedback 204, observer prompt 206, and other data. Analysis module 116 may have a plurality of submodules. Each submodule may perform a portion of an analysis for analysis module 116. Analysis module 116 may provide an analysis of participant feedback 204 in any number of ways. For example, analysis module 116 may be configured to generate subgroup feedback and consolidated feedback. Each feedback or feedback collectively may be presented in any number of ways including, for example, graphs, quotes, or other information about participant feedback 204.

In some embodiments, participant feedback 204 is analyzed by categorization module 138. Categorization module 138 may be configured to identify a category of the plurality of participant feedbacks 204, or even a single participant feedback 204. A category of the plurality of participant feedbacks 204, as used herein, is a feature, quality, or other identifier that is common to a set or subset of participant feedbacks 204. For example, if three participants' feedbacks say, “The lawn is overgrown,” “The grass looks terrible,” and “Whoever is responsible for mowing around here should be fired,” the category identified by categorization module 138 may be “landscaping.” Categorization module 138 may also identify additional sub-categories. Continuing with the previous example, categorization module 138 may further identify the landscaping as “overgrown.” In some embodiments, categorization module 138 may employ quantitative module 150 to assign a quantitative feature to the categorization. For example, quantitative module 150 may assess each of the feedback examples above as a “1” on a scale of 1-5. Categorization module 138 may use artificial intelligence to identify categories.

In some embodiments, participant feedback 204 is analyzed by theme module 140. Theme module 140 may be configured to identify a theme of the plurality of participant feedbacks 204, or even a single participant feedback 204. A theme of the plurality of participant feedback 204, as used herein, means a common overarching trait of the plurality of participant feedbacks 204. For example, an identified theme may be that people are generally satisfied with landscaping. Theme module 140 may use artificial intelligence to identify themes. Themes and categories are coextensive or different in scope, depending on the circumstance. Both may be used to describe features and traits of participant feedback 204. In some embodiments, categorization module 138 creates categories of data that are presented as themes to participants for further assessment.

Participant feedback 204 may also be analyzed by filtering module 130. In some embodiments, filtering module 130 may be configured to filter the plurality of participant feedbacks 204. Filtering module 130 may filter the plurality of participant feedback 204 using any number of filtering criteria. For example, filtering module 130 may filter the plurality of participant feedback 204 by a category or theme, as described above. Filtering module 130 may also filter the plurality of participant feedbacks 204 based on participant attributes. Filtering module 130 may also apply several filters at once and may also be configured to sort participant feedback 204.

Participant feedback 204 may also be analyzed by summary module 144. In some embodiments, summary module 144 may generate summaries of the plurality of participant feedbacks 204. These summaries may be generated using artificial intelligence, such as, for example, ChatGPT. Summary module 144 may also generate summaries of groups of the plurality of participant feedback 204. For example, summary module 144 may generate a summary of the plurality of participant feedback 204 for feedback that addresses an identified category, theme, stakeholder input, or any number of attributes of the plurality of participant feedbacks 204. In another example, summary module 144 may generate a summary of a subgroup of the plurality of participant feedbacks 204. Summary module 144 may also generate summaries based on the participant attributes.

In some embodiments, participant feedback 204 is analyzed by an action item module 148. Action item module 148 may be configured to generate action items that are reported to the facilitator. Action item module 148 may determine that a particular action should be added to an action item list by comparing stakeholder interest with participant feedback 204. When the two are in agreement, for example, action item module 148 may generate an action item. By way of a more concrete example, if a stakeholder seeks to improve a residential community for residents and offers either a pool or a park for the residents, action item module 148 may generate the action item of “build a pool” if the participant feedback 204 indicates the preference for that improvement. A stakeholder's input or other action item module 148 parameters may be stored stakeholder module 128. In some embodiments, the plurality of subsequent participant feedback solicitations 208 are generated with reference to stakeholder module 128. In some embodiments, action item module 148 may be configured to generate actionable insights for a facilitator to present to stakeholders.

In some embodiments, analysis module 116 has solicitation generation module 142. Solicitation generation module 142 may be configured to automatically generate a plurality of subsequent participant feedback solicitations 208. In some embodiments, solicitation generation module 142 is configured to generate a plurality of subsequent participant feedback solicitations 208 in real-time, as participant feedback 204 is received. Solicitation generation module 142 may generate a plurality of subsequent participant feedback solicitations 208 with reference to other data or input sources. For example, solicitation generation module 142 may generate the plurality of subsequent participant feedback solicitations 208 with reference to an identified category, theme, and stakeholder input. In some embodiments, each subsequent participant feedback solicitation 208 may be generated based on the participant attribute. Solicitation generation module 142 may generate a plurality of subsequent participant feedback solicitations 208 with reference to observer module 136, that is, after the module has evaluated the content of observer prompt 206.

Solicitation generation module 142 may use feedback solicitation module 132's translation module 122 to translate the plurality of subsequent participant feedback solicitations 208, as necessary. In some embodiments, solicitation generation module 142 is configured to automatically send a plurality of subsequent participant feedback solicitations 208 to all or some participant devices 110. In some embodiments, subsequent participant feedback solicitation 208 may be generated from themes or categories and presented to participants for real-time adjustment by participants. For example, subsequent participant feedback solicitations may include a request to rank or prioritize certain identified themes or categories from the feedback. In some further embodiments, after the participants rate the identified themes or categories, a further subsequent participant feedback solicitation may include prompting participants to select one or a subset of the identified themes or categories (or a subset thereof determined by the facilitator) that is of the most importance to the participant and ask the participant to explain the reasoning behind the selection. In some embodiments, a plurality of subsequent participant feedback solicitations 208 may be first sent to facilitator device 106 for approval before the plurality of subsequent participant feedback solicitations 208 are sent to participant devices 110. In some embodiments, especially embodiments where plurality of subsequent participant feedback solicitations 208 is generated with reference to participant identifier, a representative plurality of subsequent participant feedback solicitations 208 may be presented to facilitator device 106 as it would be impractical for a human facilitator using facilitator device 106 to review a voluminous, individualized plurality of subsequent participant feedback solicitations 208. In some embodiments, analysis module 116 includes trend identification module 152. Trend identification module 152 may be configured to identify trends in participant feedback 204 as they are received in real-time. This may aid the facilitator in determining follow-up questions and participant engagement.

In some embodiments, a graphical user interface module 118 is configured to generate a graphical user interface. Graphical user interface module 118 may be configured to generate graphical user interfaces for devices. For example, graphical user interface module 118 may be configured to generate a graphical user interface for display on facilitator device 106. In some embodiments, graphical user interface module 118 is configured to generate a graphical user interface with a plurality of sections. Each section may be configured to display different data. Additional details of graphical user interfaces will be discussed below.

FIG. 1 also shows observer module 136. Observer module 136 may be configured to manage the interactions between observer device 108 and other modules. Observer module 136 may be configured to provide a graphical user interface to observer device 108. Observer module 136 may be configured to receive observer prompt 206. In some embodiments, observer prompt 206 may be configured to provide observer prompt 206 to solicitation generation module 142, or analysis module 116 more generally. Solicitation generation module 142, for example, may make use of observer prompt 206 when automatically generating a plurality of subsequent participant feedback solicitations 208.

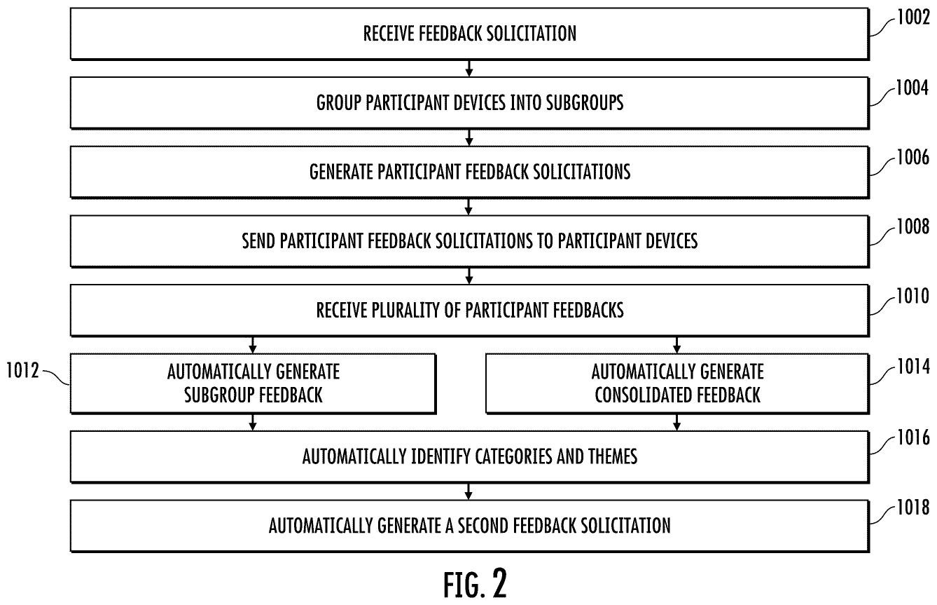

FIG. 2 shows a flow diagram showing an example process of the quantitative feedback system for generating a second feedback solicitation according to some embodiments. The process includes receiving a feedback solicitation. See, e.g., element 1002. The feedback solicitation may be received from facilitator device 106. The process also includes grouping participant devices 110 in subgroups. See, e.g., element 1004. In some embodiments, grouping module 120 may be used to group participant devices 110. The process may include generating a participant feedback solicitation. See, e.g., element 1006. In some embodiments, the participant feedback solicitations are generated by feedback solicitation module 132. The process also includes sending participant feedback solicitations to the participant devices. See, e.g., element 1008. The process may continue with receiving the plurality of participant feedbacks. See, e.g., element 1010. The process includes automatically generating subgroup feedback. See, e.g., element 1012. The process also includes automatically generating consolidated feedback. See, e.g., element 1014. The process includes automatically identifying categories and themes in the participant feedback. See, e.g., element 1016. In some embodiments, the categories and themes may be generated using categorization module 138 and theme module 140. The process includes automatically generating a second feedback solicitation. See, e.g., element 1018. The second feedback solicitation may be generated with a solicitation generation module 142.

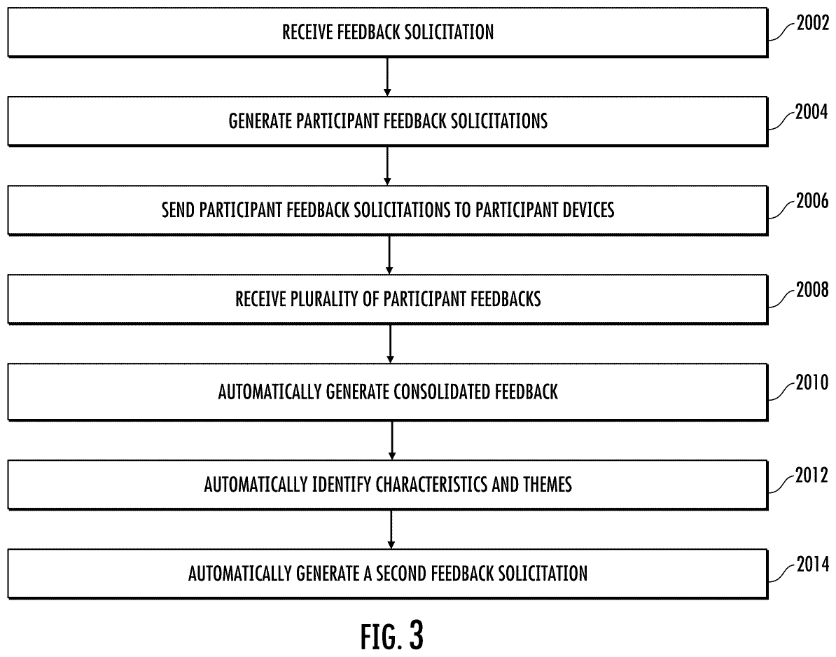

FIG. 3 shows a flow diagram showing an example process of the quantitative feedback system for automatically generating a second feedback solicitation according to some embodiments. The process includes receiving a feedback solicitation. See, e.g., element 2002. The process may include generating a participant feedback solicitation. See, e.g., element 2004. In some embodiments, the participant feedback solicitations are generated by feedback solicitation module 132. The process also includes sending participant feedback solicitations to the participant devices. See, e.g., element 2006. The process may continue with receiving the plurality of participant feedbacks. See, e.g., element 2008. The process also includes automatically generating consolidated feedback. See, e.g., element 2010. The process includes automatically identifying categories and themes in the participant feedback. See, e.g., element 2012. In some embodiments, the categories and themes may be generated using categorization module 138 and theme module 140. The process includes automatically generating a second feedback solicitation. See, e.g., element 2014. The second feedback solicitation may be generated with a solicitation generation module 142.

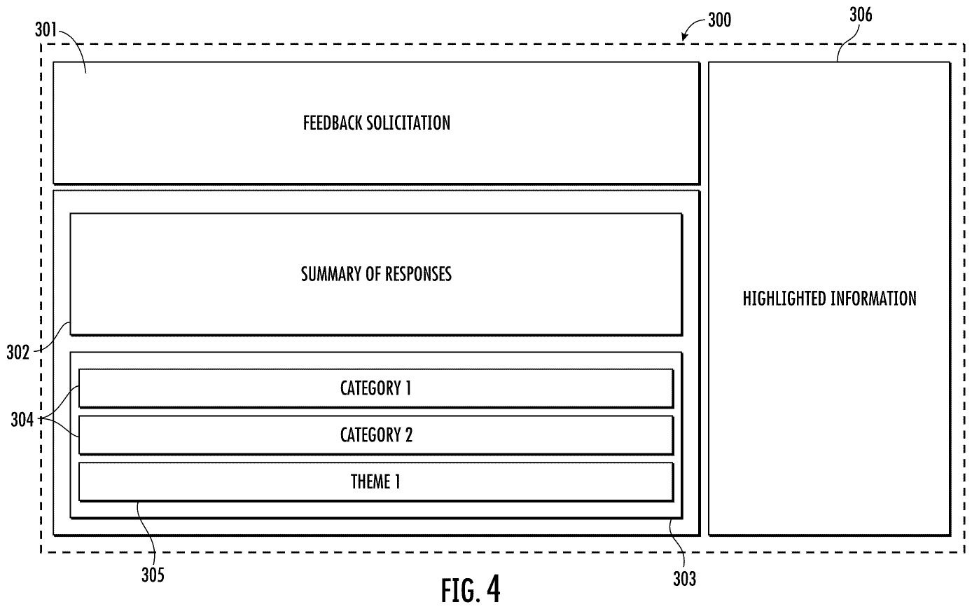

FIG. 4 shows a graphical user interface generated for a facilitator, according to some embodiments. FIG. 4 shows graphical user interface 300 with first section 301, second section 302, third section 303, and fourth section 306. Graphical user interface 300 has first section 301, second section 302, third section 303, and fourth section 306. In some embodiments, each section displays a different component of information. For example. First section 301 may display feedback solicitation 200 to remind the facilitator about the feedback sought. Second section 302 may display a summary of the participant feedback 204 generated by summary module 144. In some embodiments, summary module 144 may rely on some embodiments subgroup module 146 to generate analysis—including summaries—of the subgroup participant feedback 204.

Third section 303 may display categories 304 of the participant feedback 204 identified by categorization module 138. In some embodiments, categories 304 may be identified in participant feedback 204 by categorization module 138. In some embodiments, third section 303 may also display theme 305 of participant feedback 204. Theme 305 may be generated automatically by theme module 140. Fourth section 306 displays a participant feedback 204. As shown in fourth section 306, the participant identifying information may be provided with the quote.

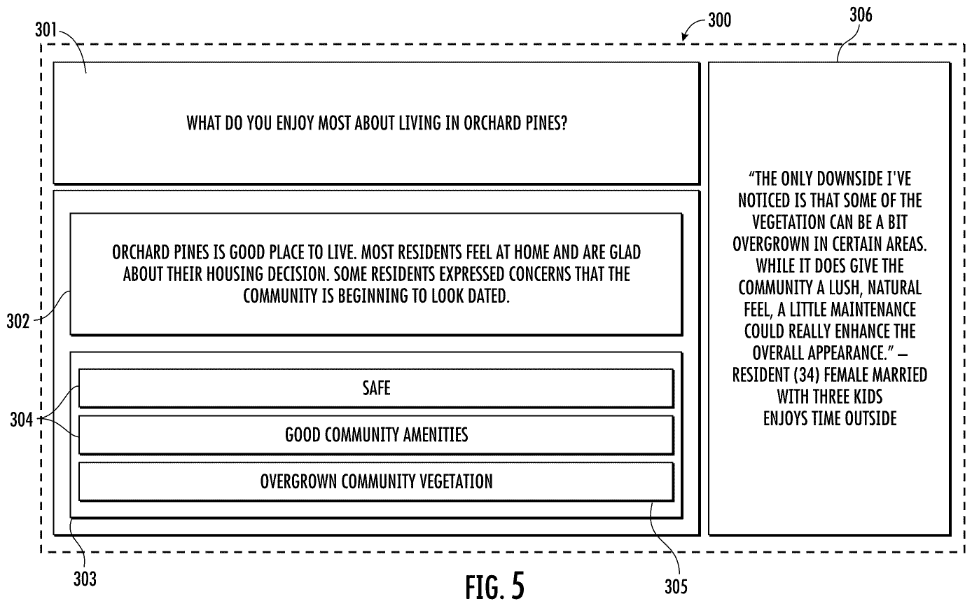

FIG. 5 shows a graphical user interface generated for a facilitator, according to some embodiments. The graphical user interface shown in FIG. 5 will be used to describe an example situation a quantitative research system 100 may be used in.

A residential property management company has residential communities in four regions. Each region has between one and five communities. The management company seeks input from residents of the communities about how it can improve the resident experience. A manager of the management company seeks to observe the feedback session. The feedback session is led by a facilitator, and approximately 20 residents from each community have been selected to participate in giving feedback.

In this scenario, the facilitator would be at facilitator device 106, each resident would be at one of the plurality of participant devices 110 with audio inputs 112 associated with each participant devices 110, and the manager of the management company would be at observer device 108. Each participant device 110 may provide a participant attribute. The participant attribute, in this example, may contain demographic information about each participant associated with each participant device 110. For example, participant attributes may include the participant's gender, age, marital status, and language preference, and identifies which region and community the participant lives in.

Facilitator device 106 may generate a feedback solicitation 200 that is broad, for example, “What do you enjoy most about living in the community?”. Feedback solicitation 200 is received by communication module 114. Processor 104 may employ feedback solicitation module 132 to generate a plurality of participant feedback solicitations 202. Each of the plurality of plurality of participant feedback solicitations 202 may be individualized to each participant device 110. For example, the plurality of participant feedback solicitations 202 may rephrase the question for each participant based on the community they live in and the participant's language preference. In some embodiments, instead of text-based feedback solicitation 200, feedback solicitation 200 could be asked in a live session by the facilitator associated with facilitator device 106.

Processor 104 causes the plurality of participant feedback solicitations 202 to be sent to participant devices 110 via communication module 114. Each participant at participant device 110 may then respond by speaking a response which is captured by each participant device 110's audio input 112. The audio input 112 is received by communication module 114 as participant feedback 204. In this example, each participant feedback 204 is anonymized so neither facilitator device 106 nor observer device 108 can associate a particular participant feedback 204 with a resident.

In some embodiments, audio input 112 includes a quantitative component. For example, the user may be able to rate—by speaking into audio input 112—their feedback as they give it. The user may state, “I rate this a five out of five in importance to me.” In some embodiments, analysis module 116 includes a quantitative module 150. Quantitative module 150 may be configured to determine a quantitative property of the audio feedback received from participant devices 110 by audio input 112. For example, if the participant is particularly animated when responding to a question about a certain topic, quantitative module 150 may determine that, quantitatively, this topic or category is of the utmost importance to the participant. In some embodiments, quantitative module 150 may be configured to generate relative quantitative property. The relative quantitative property may be relative to the individual participant device 110 (i.e. the participant associated with this device ranks A as more important than B), or the relative quantitative property may be relative to the group (i.e. this participant carted more about topic A than most participants). In some embodiments, quantitative module 150 uses a rate function to facilitate that quantitative ranking of participant feedback 204.

As participant feedback 204 is received by communication module 114, it is analyzed by analysis module 116. In some embodiments subgroup module 146 analyzes the data received from each subgroup of participant devices 110. In some embodiments, categorization module 138 determines categories of the plurality of participant feedback solicitations 202. In some embodiments, the categories may be generated for a subgroup of participant devices 110. Theme module 140 may generate one or more themes of plurality of participant feedback solicitations 202.

FIG. 5 shows a graphical user interface 300. Graphical user interface 300 may be presented to facilitator device 106. Graphical user interface 300 has a first section 301, a second section 302, a third section 303, and a fourth section 306. In some embodiments, each section displays a different component of information. For example. First section 301 may display feedback solicitation 200 to remind the facilitator about the feedback sought. In this example, the facilitator is reviewing the data, either sorted or grouped, to focus on responses from one of the management companies' communities, “Orchard Pines.” Second section 302 may display a summary of the participant feedback 204 generated by summary module 144. In some embodiments, summary module 144 may rely on some embodiments subgroup module 146 to generate analysis—including summaries—of the subgroup participant feedback 204.

Third section 303 may display categories 304 of the participant feedback 204 identified by categorization module 138. In some embodiments, categories 304 may be identified in participant feedback 204 by categorization module 138. In some embodiments, third section 303 may also display theme 305 of participant feedback 204. Theme 305 may be generated automatically by theme module 140. Fourth section 306 displays a participant feedback 204. As shown in fourth section 306, the participant identifying information may be provided with the quote.

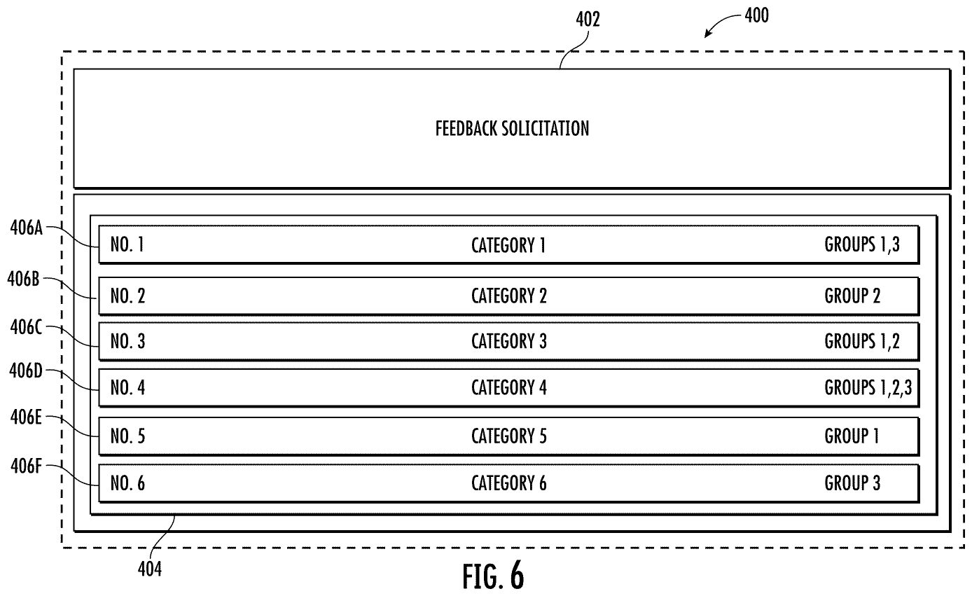

FIG. 6 shows a graphical user interface generated for a facilitator, according to some embodiments. The embodiment shown in FIG. 6 may be generated after a feedback session has been conducted. FIG. 6 shows graphical user interface 400 that has first section 402 and second section 404. First, section 402 may display information related to feedback solicitation 200, participant feedback 204, or other information. Second section 404 may display a plurality of categories 406A-F. Categories 406 may be automatically generated from the plurality of participant feedback 204. As shown in FIG. 6, the automatically generated plurality of categories 406A-F may be ranked by a metric, and the display of each category 406 may identify a source of the data or where the identified category 406 is particularly prevalent, for example.

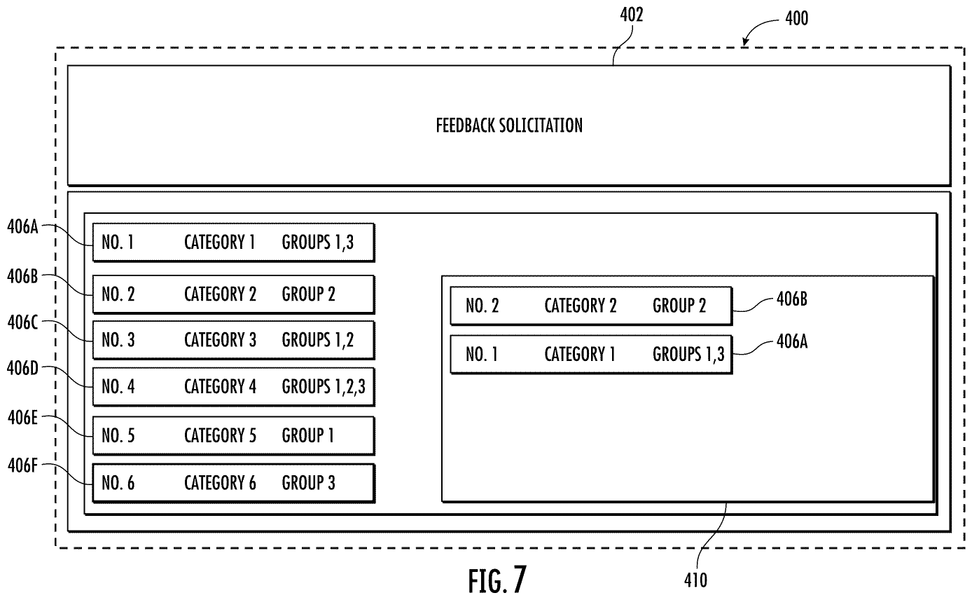

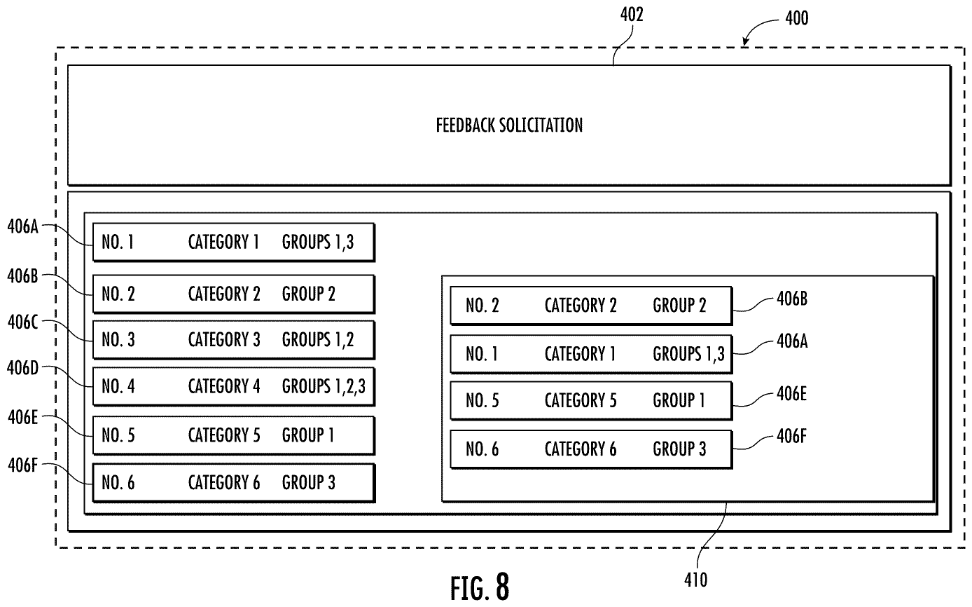

FIG. 7 shows a graphical user interface generated for a facilitator, according to some embodiments. Like the graphical user interface shown in FIG. 6, FIG. 7 shows graphical user interface 400 that displays plurality of identified categories 406A-F. FIG. 7 also shows selection region 410. Selection region 410 may be a section of graphical user interface 400 that is configured to receive categories 406A-F. A user may select some or all of categories 406A-F by moving the graphical repression of category 406A to selection region 410. In selection region 410 the facilitator may be able to view subsets of the selected categories 406 or sort the importance of the categories to the facilitator. FIG. 7 shows that the facilitator has selected categories 406B and 406A. FIG. 8 shows a similar display as FIG. 7, except that categories 406E and 406F are also selected. The facilitator may reject automatically generated categories 406 for any number of reasons. For example, the rejected category 406 may be irrelevant to the solution the facilitator is receiving feedback about. The automatic generation of categories by the categorization module allows categories to be identified without a human facilitator's bias. Additionally, the categorization module may rely on historical data of similar responses to similar questions in a similar setting. The historical data may be used to identify outliers in the data, may be used to weight categorization rankings, and may be used to identify any expected data that may not have been captured. Gathered data may also include historical data. Any module may rely on further demographic data when analyzing or filtering results. For example, a module may communication with a privately or publicly available demographics database to determine demographic data of the participants.

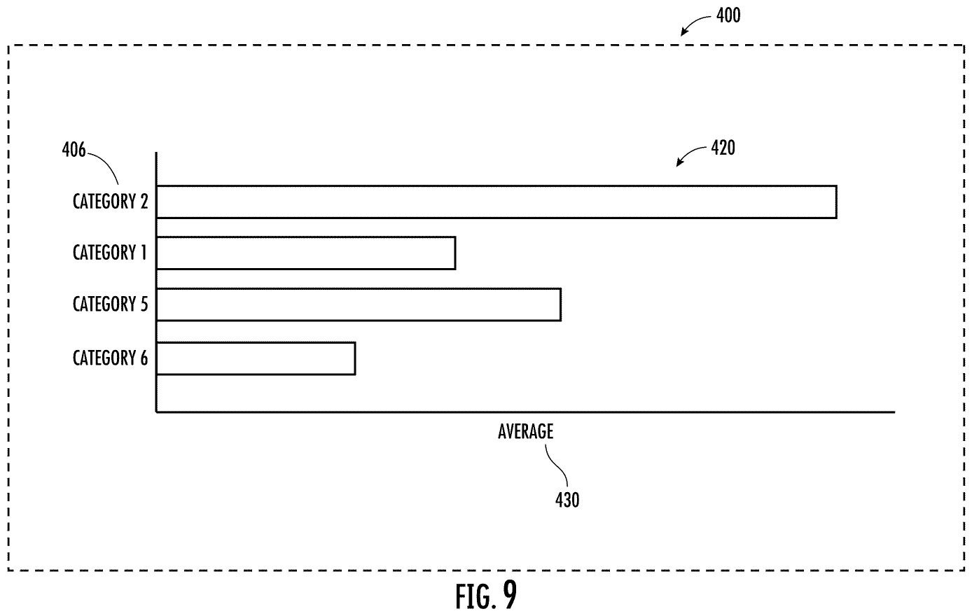

FIG. 9 shows a graphical user interface generated for a facilitator, according to some embodiments. The embodiment shown in FIG. 9 may be the “next screen” a facilitator sees after FIG. 8's categorization selection screen. FIG. 9 shows categories 406 selected by the facilitator graphed in graph 420 against a metric 430. Metric 430 may be an average, count, or other metric of the data.

In some embodiments, after a facilitator has selected categories 406, the facilitator may ask each participant to rate how important each category 406 is to the participant. In this way, the participant may rate, in real-time, the importance of each category 404 to the participant. This also operates to provide a subjective check by the facilitator or the participant of the objective analysis of the data performed by the analysis module.

In some embodiments, facilitator device 106 may send multiple feedback solicitation 200 to communication module 114. Each feedback solicitation 200 may request feedback on a different topic. For example, if the facilitator asks three questions each about a topic to a group of 40, feedback solicitation module 132 may make a determination about how many, of the 40 participants, need to respond so that the responses have a statistical likelihood of being representative of either the responses of the 40 participants, or as being representative of the larger group from which the 40 participants are drawn. In some embodiments, the determination about how many participant responses are required is made with reference to a confidence interval. This method can save time because, in some use cases, it may only be necessary to send a small number of questions to each participant device. Thus, the overall length of the feedback session is minimized.

Some embodiments disclosed herein are described in relation to quantitative (for example, large-scale (1000+participants) surveys that are aligned with the representative demographics of a community, organization, country, etc., and are projectible within a margin of error) feedback. The principles disclosed herein are equally applicable to both quantitative systems and qualitative (for example, feedback that may have a subjective, interpretive component) systems.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including one programmable processor, which may be special or general purpose, coupled to receive data and instructions from, and to transmit data and instructions to, a storage system, one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse by which the user can provide input to the computer. Other kinds of devices can be used to provide for interaction with a user as well; for example, feedback provided to the user can be any form of sensory feedback (e.g., visual feedback, auditory feedback, and/or tactile feedback) and input from the user can be received in any form, including acoustic, speech, and/or tactile input.

The systems and techniques described here may be implemented in a computing system that includes a back-end component (e.g., as a data server), a middleware component (e.g., an application server), a front-end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In an embodiment, the client and the server are remote from each other and interact through the communication network. In some embodiments, a memory on a server stores programs or modules that run on the processor.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

Where the above examples, embodiments and implementations reference examples, it should be understood by those of ordinary skill in the art that other methods could be intermixed or substituted with those provided. In places where the description above refers to particular methods, it should be readily apparent that a number of modifications may be made without departing from the spirit thereof and that these embodiments and implementations may be applied to other to educational technologies as well. Accordingly, the disclosed subject matter is intended to embrace all such alterations, modifications and variations that fall within the spirit and scope of the disclosure and the knowledge of one of ordinary skill in the art.

What is claimed is:

1. A system for prescribing actionable tasks from iterative, real-time participant input to advance a strategic plan, the system comprising:
a server communicatively coupled to a plurality of participant devices and at least one facilitator device; and
a processor communicatively coupled to the server and configured to:
receive, from each participant device, a participant identifier;
receive, from the at least one facilitator device, a feedback solicitation;
group, using a grouping module, the plurality of participant devices into subgroups, the grouping module configured to group the plurality of participant devices based on the participant identifier and the feedback solicitation;
generate, using a participant feedback solicitation module, a participant feedback solicitation for each participant device in each subgroup;
send, using the participant feedback solicitation module, the participant feedback solicitation to each participant device in each subgroup;
receive in real-time, a plurality of participant feedbacks from the plurality of participant devices, the plurality of participant feedbacks comprising inputs from each of the participant devices;
generate, from the plurality of participant feedbacks, a subgroup feedback and a consolidated feedback, the subgroup feedback and the consolidated feedback generated automatically by an analysis module configured to identify at least one category of the plurality of participant feedbacks and identify at least one theme of the plurality of participant feedbacks;
present, using a graphical user interface module, the consolidated feedback to the facilitator device using a graphical user interface that includes at least one identified category of the plurality of participant feedbacks and at least one identified theme of the plurality of participant feedbacks;
generate, with references to a stakeholder input module, a second participant feedback solicitation, the second participant feedback solicitation generated by the analysis module with reference to the category, theme, and a stakeholder input identified in the stakeholder input module; and
generate in real-time and display at the graphical user interface actionable tasks to advance the strategic plan based on responses to the second participant feedback solicitation.

2. The system of claim 1, wherein the server is communicatively coupled to an observer device, and wherein the processor is further configured to receive an observer prompt from the observer device.

3. The system of claim 2, wherein the second participant feedback solicitation is generated by the analysis module with reference to the observer prompt.

4. The system of claim 1, wherein the participant solicitation feedback module further comprises a translation module, the translation module configured to translate the participant feedback solicitation into a language of the participant device.

5. The system of claim 1, wherein the processor is further configured to generate, using an action item module, a plurality of action items, the plurality of action items generated automatically by the action item module by comparing at least one stakeholder input to the at least one category of the plurality of participant feedbacks.

6. The system of claim 1, wherein the analysis module comprises a filtering module configured to automatically filter the plurality of participant feedbacks.

7. The system of claim 6, wherein the filtering module is configured to filter the plurality of participant feedbacks by an attribute of each participant device, wherein the attribute of each participant includes one of a participant age and a participant gender.

8. The system of claim 1, wherein the graphical user interface generated for the facilitator device comprises:
a first section displaying the category of the plurality of participant feedbacks; and
a second section displaying at least one of the plurality of participant feedbacks from one of the plurality of participant devices.

9. The system of claim 8, wherein the analysis module is configured to identify a second category of the feedback, and wherein the first section of the graphical user interface generated for the facilitator displays the second category of the plurality of participant feedbacks.

10. The system of claim 1, wherein the grouping module is configured to group the plurality of participant devices based on a facilitation metric.

11. The system of claim 1, wherein the input is an audio input, and wherein the receipt of the plurality of participant feedbacks from the participant devices further includes, automatically translating, using a translation module, the audio inputs from each participant device into a selected language.

12. The system of claim 1, further comprising a trend identification module configured to identify trends in the plurality of participant feedbacks.

13. A system for prescribing actionable tasks from iterative real-time participant input to advance a strategic plan, the system comprising:
a server having a processor configured to:
receive, from a facilitator device communicatively coupled to the server, a facilitator feedback solicitation;
generate, from the facilitator feedback solicitation, a plurality of feedback solicitations,
send, to a plurality of participant devices communicatively coupled to the server, one of the plurality of feedback solicitations;
receive in real-time, from each participant, a participant feedback, wherein each participant's feedback comprises an input;
summarize, using a summary module, the participant feedbacks into a summarized feedback;
identify in real-time a category of the summarized feedback;
generate a graphical user interface displaying a facilitator view, the facilitator view comprising:
a first section displaying the summarized feedback;
a second section displaying the category of the summarized feedback; and
a third section displaying at least one participant feedback from one of the plurality of participants in support of the category of the summarized feedback; and
generate a subsequent feedback solicitation as a rate function based on feedback received from each participant and a strategic stakeholder interest; and
generate in real-time and display at the facilitator device actionable tasks to advance the strategic plan based on responses to the rate function.

14. The system of claim 13, wherein the subsequent feedback solicitation comprises a plurality of subsequent feedback solicitations, each of the plurality of subsequent feedback solicitations generated for a specific participant device.

15. The system of claim 13, wherein the processor is further configured to group, using a grouping module, the plurality of participant devices into subgroups, each participant device being assigned to the subgroup based on a common facilitation metric.

16. A system for prescribing actionable tasks from iterative real-time participant input to advance a strategic plan, comprising:
a server communicatively coupled to a plurality of participant devices and at least one facilitator device; and
a processor communicatively coupled to the server and configured to:
receive, from the at least one facilitator device, a feedback solicitation;
generate, using a participant feedback solicitation module, a participant feedback solicitation;
send, using the participant feedback solicitation module, the participant feedback solicitation to each participant device;
receive, from each participant device, a plurality of participant feedbacks, the plurality of participant feedbacks comprising an input from each of the participant devices;
generate, from the plurality of participant feedbacks, a consolidated feedback, the consolidated feedback generated automatically by an analysis unit configured to identify at least one category of the plurality of participant feedbacks,
present, using a graphical user interface module, the consolidated feedback to the facilitator device using a graphical user interface that includes at least one identified category of the plurality of participant feedbacks; and
generate, with references to a stakeholder input module, a second participant feedback solicitation, the second participant feedback solicitation generated by the analysis module with reference to the category of the plurality of participant feedbacks and a stakeholder input identified in the stakeholder input module.

17. The system of claim 16, wherein the analysis module is further configured to identify a theme of the plurality of participant feedbacks.

18. The system of claim 17, wherein the analysis module is configured to generate the consolidated feedback based on at least one theme of the plurality of participant feedback.

19. The system of claim 16, wherein the second participant feedback solicitation is generated based on the theme of the plurality of participant feedbacks.

20. The system of claim 16, wherein generating the participant feedback solicitation for each participant device comprises a determination of a language of the participant device.
